(19) United States
(12) Patent Application Publication
(10) Pub. No.: US 2015/0291266 A1
(43) Pub. Date: Oct. 15, 2015

(54) PORTABLE PADDLEBOARD MOUNTED SEAT

(71) Applicant: BRIAN ROBERT WROBLEWSKI, Long Beach, CA (US)

(72) Inventor: BRIAN ROBERT WROBLEWSKI, Long Beach, CA (US)

(21) Appl. No.: 14/267,761

(22) Filed: May 1, 2014

Related U.S. Application Data
(60) Provisional application No. 61/979,458, filed on Apr. 14, 2014.

(51) Int. Cl. B63B 35/85; B60N 2/28

(52) U.S. Cl. CPC B63B 35/85; B60N 2/28

(57) ABSTRACT

Some embodiments of the present disclosure include a portable paddleboard mounted seat including a seat, a forward trunk attached to a forward end of the seat, an aft trunk attached to a back end of the seat, and a seat support attached to a bottom surface of the seat, the seat support extending downward from the bottom surface. The forward trunk may be a canted vertical forward trunk having a handle and a pair of forward legs, while the aft trunk may be a canted vertical aft trunk having a pair of aft legs. The portable paddleboard mounted seat may be configured to removably attach to a paddleboard and may be configured to hold a passenger. In embodiments, the seat support may have a tie down orifice configured to engage with an attachment loop, which may be configured to removably engage with a hook attached to the paddleboard.

### RELATED APPLICATION

This application claims priority to provisional patent application U.S. Ser. No. 61/979,458 filed on Apr. 14, 2014, the entire contents of which is herein incorporated by reference.

### BACKGROUND

The embodiments herein relate generally to water sports, and more particularly, to a portable paddleboard mounted seat.

Paddleboarding can, and should be, a family affair. However, riding a paddleboard with another person, such as a child, may disturb the paddleboards center of balance due to the inclination of the other person to move around. Disturbing the center of balance of a paddleboard creates a potentially unstable platform from which to paddle. Stability, and therefore safety, along with comfort may be compromised.

Therefore, what is needed is a device configured to maintain the center of balance of the paddleboard, while also keeping a passenger steady and relatively still on the paddleboard.

### SUMMARY

Some embodiments of the present disclosure include a portable paddleboard mounted seat including a seat, a forward trunk attached to a forward end of the seat, an aft trunk attached to a back end of the seat, and a seat support attached to a bottom surface of the seat, the seat support extending downward from the bottom surface. The forward trunk may be a canted vertical forward trunk having a handle and a pair of forward legs, while the aft trunk may be a canted vertical aft trunk having a pair of aft legs. The portable paddleboard mounted seat may be configured to removably attach to a paddleboard and may be configured to hold a passenger. In embodiments, the seat support may have a tie down orifice configured to engage with an attachment loop, which may be configured to removably engage with a hook attached to the paddleboard.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention in use.

FIG. 2 is a perspective view of one embodiment of the present invention.

FIG. 3 is an exploded perspective view of one embodiment of the present invention.

FIG. 4 is a side view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a seat for a paddleboard passenger and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

1. Seat

2. Forward Trunk

3. Aft Trunk

The various elements of the portable paddleboard mounted seat for a paddleboard passenger of the present disclosure may be related in the following exemplary fashion. It is not intended to limit the scope or nature of the relationships between the various elements and the following examples are presented as illustrative examples only.

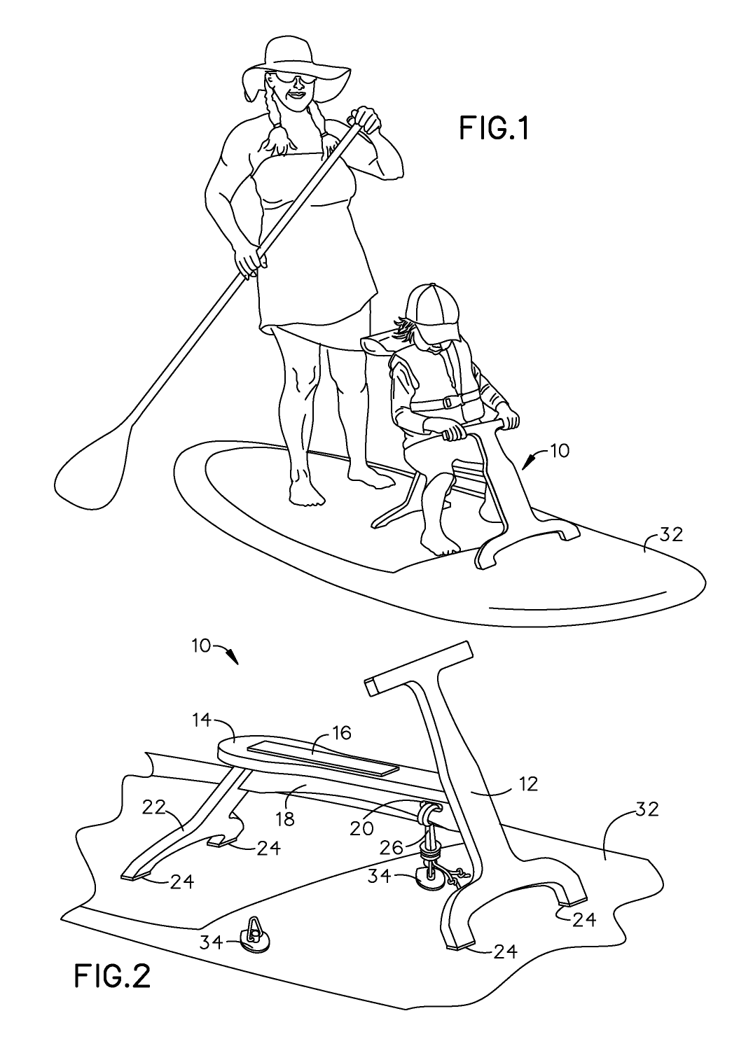

By way of example, and referring to FIGS. 1-4, some embodiments of the portable paddleboard mounted seat 10 of the present disclosure comprise a seat 14 having a forward end and a back end, the forward end being attached to a forward trunk 12 and the back end being attached to an aft trunk 22, wherein the portable paddleboard mounted seat 10 is configured to removably attach to a paddleboard 32. The seat 14 may have any shape that permits a passenger to place one leg on either side of the seat 14 when in use.

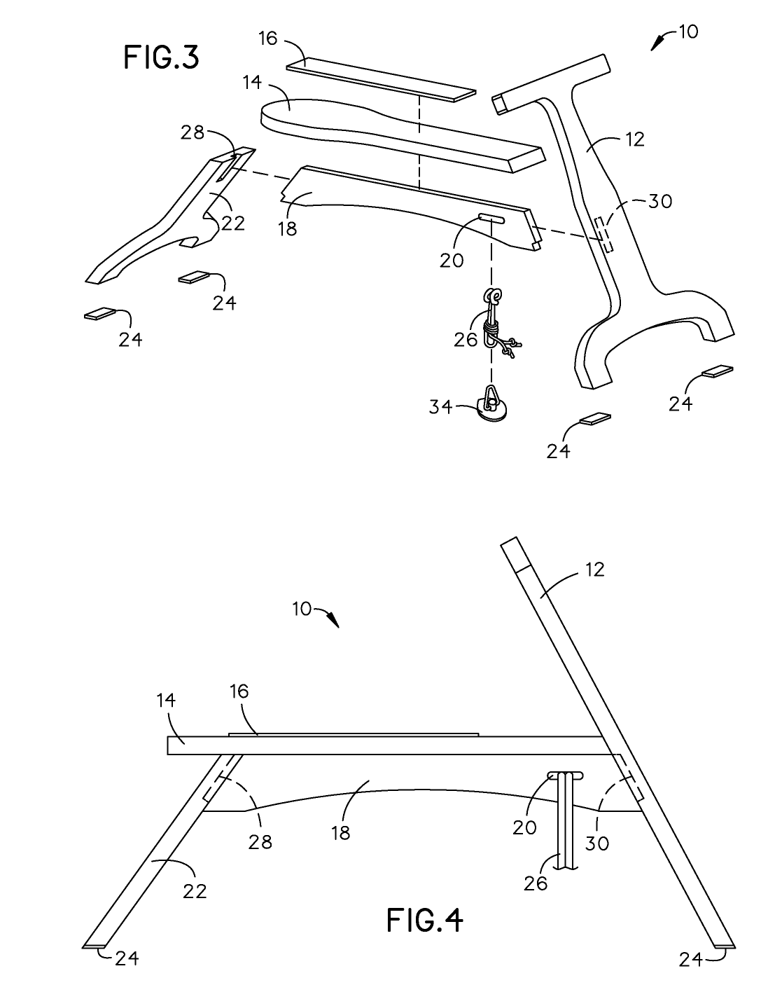

As shown in FIGS. 2 and 3, the forward trunk 12 may comprise a canted vertical forward trunk comprising a handle and a pair of forward legs, and the aft trunk may comprise a canted vertical aft trunk comprising a pair of aft legs. A bottom surface of each of the forward legs and aft legs may have a foot pad 24 attached thereto, which may be configured to be positioned on a surface of a paddleboard 32 and which may prevent the surface of the paddleboard 32 from being scratched or damaged by the feet of the forward and aft legs and may prevent the portable paddleboard mounted seat 10 from sliding around on the surface of the paddleboard 32.

As shown in FIGS. 2-4, the portable paddleboard mounted seat 10 may further comprise a seat support 18. The seat support 18 may be attached to and extend substantially perpendicularly downward from a bottom surface of the seat 14, while also running lengthwise along a center of the bottom surface of the seat 14. The seat support 18 may have a proximal end and a distal end, wherein the proximal end is configured to engage with the forward trunk 12 and the distal end is configured to engage with the aft trunk 22. For example, as shown in FIGS. 3 and 4, each of the distal end and the proximal end of the seat support 18 may comprise a tab configured to engage with a back seat support slot 28 in the aft trunk 22 and a forward support seat slot 30 in the forward trunk 12, respectively. As shown in FIGS. 3 and 4, when the seat support 18 is attached to the aft trunk 22 and the forward trunk 12, the seat support 18 may be flush with an upper surface of the aft trunk 22 and may create a level surface to which the seat 14 may be attached.

As shown in FIGS. 2-4, the seat support 18 may further comprise a tie down orifice 20 configured to engage with an attachment loop 26, wherein the attachment loop 26 may be configured to engage with a hook 34 removably attached to a surface of the paddleboard 32. In some embodiments, the tie down orifice 20 may be positioned proximate to the proximal end of the seat support 18 and may be located at a position substantially vertically below the handle of the forward trunk 12 when the portable paddleboard mounted seat 10 is assembled, as shown in FIG. 4. As shown in FIGS. 2 and 3, in some embodiments, the hook 34 may be a self-adhesive nylon loop, such as a 3M based peel and stick adhesive hook, which may be adhered to a position on the paddleboard 32 that is substantially centrally located with respect to a width of the paddleboard 32. In embodiments, there may be multiple hooks 34 used to secure the portable paddleboard mounted seat 10. The attachment loop 26 may be any suitable strap, such as a webbing and nylon loop having a width of about 1 inch or a bungee, elastic strap. In embodiments, the attachment loop 26 may be adjustable, allowing the portable paddleboard mounted seat 10 to be properly secured to the paddleboard 32. In alternate embodiments, the portable paddleboard mounted seat 10 may be attached to the paddleboard using any suitable or conventional fastener.

In some embodiments, the portable paddleboard mounted seat 10 may further comprise a seat pad 16 attached to a top surface of the seat 14, as shown in FIGS. 2-4. The seat pad 16 may be substantially rectangular, as shown in the figures, or it may be any other desired shape. The seat pad 16 may run lengthwise along the top surface of the seat 14 from a position proximate to forward trunk 12 to a position proximate to the aft trunk 22. The seat pad 14 may be added for comfort and cushioning for the rider of the portable paddleboard mounted seat 10.

The portable paddleboard mounted seat 10 may be made of any conventional material and, in embodiments, is made from Baltic birch plywood, which is a dense plywood. The different pieces may be attached using any conventions fasteners and, in embodiments, are attached to one another using adhesive, such as wood glue and deck screws. In some embodiments, a dado joint may be cut in the pieces to aid in the assembly of the portable paddleboard mounted seat.

To install the portable paddleboard mounted seat 10, a user may position a self adhesive hook 34 to a central portion of the surface of the paddleboard 32. A user may then center the portable paddleboard mounted seat 10 over the hook 34, attaching the portable paddleboard mounted seat 10 to the hook 34 using the attachment loop 26. A child or other paddleboard passenger may then straddle the seat 14 of the portable paddleboard mounted seat 10 facing the forward trunk 12 and, optionally, gripping the handle of the forward trunk 12, when included. Thus, the passenger may be positioned above a top surface of the paddleboard 32. As a result of the passenger straddling the portable paddleboard mounted seat 10, the passenger's weight may be substantially centered on the paddleboard 32, which may result in the paddleboard 32 being more stable than if the passenger is not using the portable paddleboard mounted seat 10.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

1. A portable paddleboard mounted seat for a paddleboard passenger, the portable paddleboard mounted seat comprising:
a seat comprising a forward end and a back end;
a forward trunk attached to the forward end of the seat, the forward end comprising a canted vertical forward trunk comprising a handle and a pair of forward legs, wherein the handle is an extension of the canted vertical forward trunk and extends vertically above the seat; and
an aft trunk attached to the back end of the seat,
wherein:
the portable paddleboard mounted seat is configured to removably attach to a paddleboard; and
the portable paddleboard mounted seat is configured to hold a passenger.

2. The portable paddleboard mounted seat of claim 1, further comprising a seat support attached to a bottom surface of the seat, the seat support extending substantially perpendicularly downward from the bottom surface and extending along a central portion of the bottom surface of the seat from the forward trunk to the aft trunk.

3. The portable paddleboard mounted seat of claim 2, wherein the seat support comprises a tie down orifice configured to engage with an attachment loop, wherein the attachment loop is configured to removably engage with a hook attached to a surface of the paddleboard.

4. The portable paddleboard mounted seat of claim 3, wherein the hook is a self-adhesive hook.

5. The portable paddleboard mounted seat of claim 3, wherein the surface of the paddleboard to which the hook is attached is substantially centrally located with respect to a width of the paddleboard.

6. The portable paddleboard mounted seat of claim 1, wherein:
the aft trunk comprises a canted vertical aft trunk comprising a pair of aft legs.

7. The portable paddleboard mounted seat of claim 6, wherein a bottom surface of each of the forward legs and the aft legs comprises a foot pad attached thereto.

8. The portable paddleboard mounted seat of claim 1, further comprising a seat pad attached to an upper surface of the seat.

9. A portable paddleboard mounted seat for a paddleboard passenger, the portable paddleboard mounted seat comprising:
a seat comprising a forward end and a back end;
a forward trunk attached to the forward end of the seat, the forward trunk comprising a canted vertical forward trunk comprising a handle and a pair of forward legs, wherein the handle is an extension of the canted vertical forward trunk and extends vertically above the seat;
an aft trunk attached to the back end of the seat, the aft trunk comprising a canted vertical aft trunk comprising a pair of aft legs; and
a seat support attached to a bottom surface of the seat, the seat support extending substantially perpendicularly downward from the bottom surface and extending along a central portion of the bottom surface of the seat from the forward trunk to the aft trunk,
wherein:
the portable paddleboard mounted seat is configured to removably attach to a paddleboard; and
the portable paddleboard mounted seat is configured to hold a passenger.

10. The portable paddleboard mounted seat of claim 9, wherein the seat support comprises a tie down orifice configured to engage with an attachment loop, wherein the attachment loop is configured to removably engage with a hook attached to a surface of the paddleboard.
